(19) United States
(12) Patent Application Publication
(10) Pub. No.: US 2016/0128302 A1
(43) Pub. Date: May 12, 2016

(54) Dog Shower

(71) Applicants: Marshall Stauber, Hollywood, FL (US); Justin Stauber, Hollywood, FL (US)

(72) Inventors: Marshall Stauber, Hollywood, FL (US); Justin Stauber, Hollywood, FL (US)

(21) Appl. No.: 14/937,653

(22) Filed: Nov. 10, 2015

Related U.S. Application Data
(60) Provisional application No. 62/077,879, filed on Nov. 10, 2014.

(51) Int. Cl. A01K 13/00

(52) U.S. Cl. CPC A01K 13/001

(57) ABSTRACT

The present invention is an animal care system having a wall with head access and a plurality of showerheads formed therewith whereby the showerheads are supplied with water from a conventional garden hose.

### INDEX TO RELATED APPLICATIONS

This application is a non-provisional of and claims benefit to U.S. Provisional Patent Application Ser. No. 62/077,879 filed Nov. 10, 2014 the disclosure of which is incorporated herein by references in its entirety.

### BACKGROUND OF THE INVENTION

The pet industry is replete with products in order to properly care for one's pets. One area of difficulty has always been debasing of a pet, for example, a dog. While some dogs are cooperative. A vast majority resists. Further, there is no effective system currently for washing a dog outdoors other than using a standard garden hose. The present invention addresses this deficiency.

### SUMMARY OF THE INVENTION

Although the invention is described in terms of care for dogs, this is for illustrative purposes. The invention is contemplated as being modifiable and configurable for all animals. In one embodiment, the invention is configurable for use with humans and is contemplated as either or both of a cleaning system and a disinfectant system.

While some dogs might cooperate and allow themselves to be bathed in a bathtub, it often presents many difficulties when trying to bathe the dog indoors. The present invention provides a system whereby a frame includes a plurality of showerheads and an interior cavity that allows the user to bathe a dog outdoors safely and effectively.

In one embodiment, the present invention is a dog and/or animal care assembly comprising:

a frame defining a multisided solid and a central cavity therein;

a plurality of delivery structures being showerheads or outlet nozzles within said central cavity;

a plurality of wall sections on said frame wherein one wall has an opening constructed and arranged for accommodating an animal's head; and

a water inlet structure operatively associated with said delivery structures for supplying water from said inlet through a connected conduit to each of said delivery structures.

In one embodiment, the present invention is a human care assembly comprising:

a frame defining a multisided solid and a central cavity therein;

a plurality of outlets within and aimed within said central cavity;

a plurality of wall sections on said frame wherein one wall has optionally, an opening constructed and arranged for accommodating a person's head;

inlet structure operatively associated delivery structures for supplying water from said inlet to each of said showerheads.

As generally understood, the delivery conduit structures are hoses and/or hose like structures. In one embodiment, the frame members are hollow and serve as the conduit or hose like structure.

In one embodiment, the invention further comprises a retaining bar on an exterior portion of said frame for inhibiting an animal from exiting through said wall opening.

In one embodiment, the water delivery structure are configured as frame members having a hollow interior conduit configured to transport water from said inlet to said showerheads. That is to say, the frame is constructed and arranged of hollow tubing such that water and/or gas travels from the inlet, through the frame and exits out at least one showerhead and/or nozzle.

In one embodiment, the opening is selectively adjustably size restrictive in construction to prevent an animal from passing through.

In one embodiment, the invention further comprises a cleaning solution reservoir and a valve configured for selective delivery of a cleaning solution concurrently with water supplied through said inlet.

In one embodiment, the invention further comprises a gas inlet configured to deliver gas through said delivery structures.

In one embodiment, the invention further comprises a gas inlet includes a heater configured for heating gas delivered to said delivery structures.

In one embodiment, gas containing a therapeutic agent is introduced through the gas inlet and exits through one or more nozzles to deliver said therapeutic agent to an animal positioned within the device. The gas either contains the therapeutic agent upon delivery to the inlet, or, in one embodiment, the gas inlet is further configured to meter a therapeutic agent into the gas stream for delivery to the animal.

In one embodiment, the same structure is used to selectively deliver liquid and gas. The showerheads as described are outlet nozzles placed within the central cavity and aimed to selectively deliver either liquid or gas.

In another embodiment, the device includes separate nozzles or showerheads for delivery of each of liquid and gas.

In one embodiment, the present invention is an animal care assembly consisting essentially of:

a frame defining a multisided solid and a central cavity therein;

a plurality of nozzle outlets positioned within and aimed within said central cavity, said nozzle outlets are constructed and arranged to deliver liquid, gas, or both, but not simultaneously;

a plurality of wall sections on said frame wherein, optionally, one wall has an opening constructed and arranged for accommodating an animal's head;

inlet structure operatively associated with said nozzle outlets for supplying liquid or gas from said inlet, through conduits to each of said outlets. In one embodiment, the conduits are the interior hollow sections of the frame.

### BRIEF DESCRIPTION OF THE SEVERAL VIEWS OF THE DRAWINGS

FIG. 1 is side perspective view according to one embodiment of the present invention.

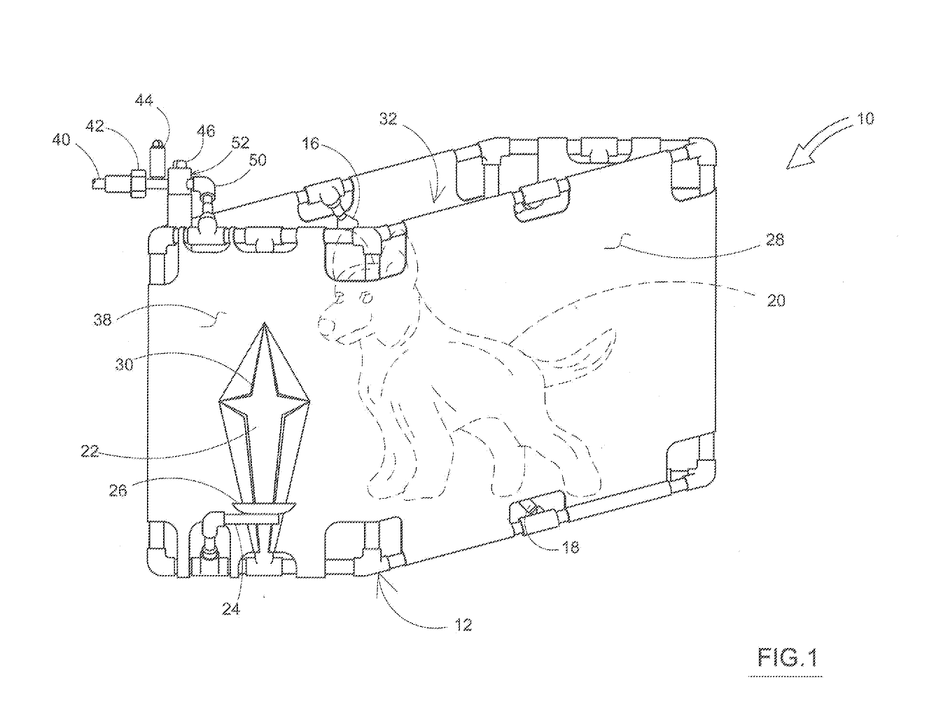

FIG. 2 is a side view of one embodiment of the present invention.

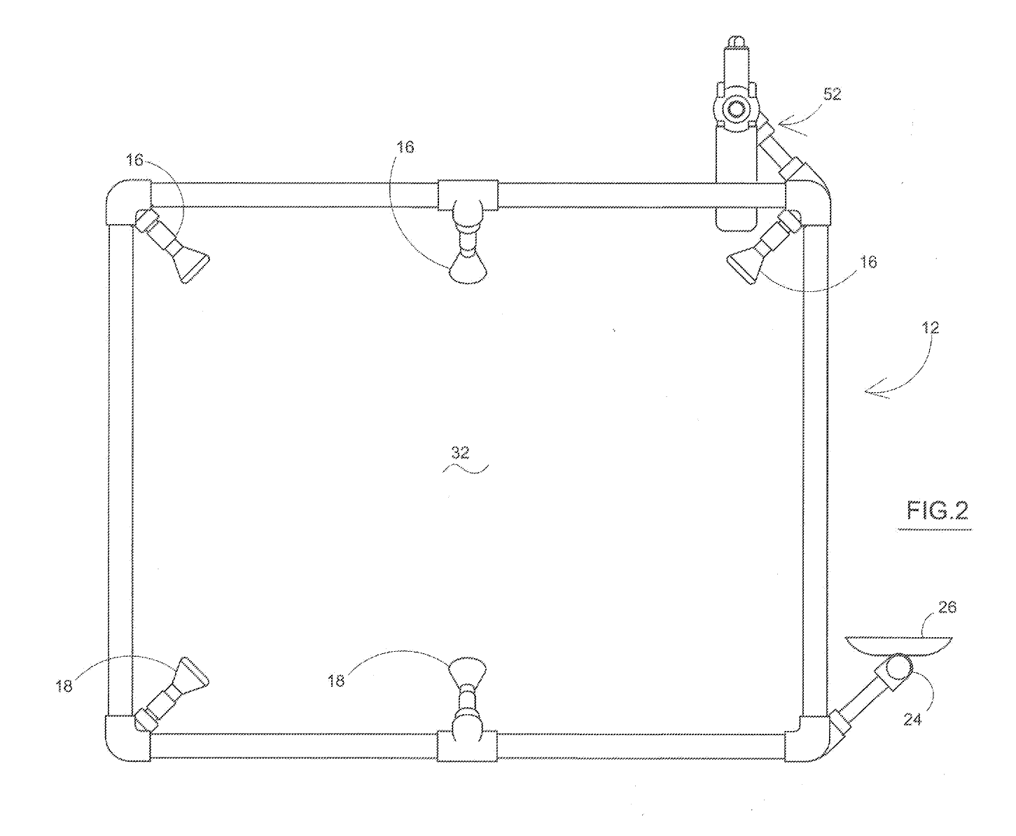

FIG. 3 is a top view of one embodiment of the present invention.

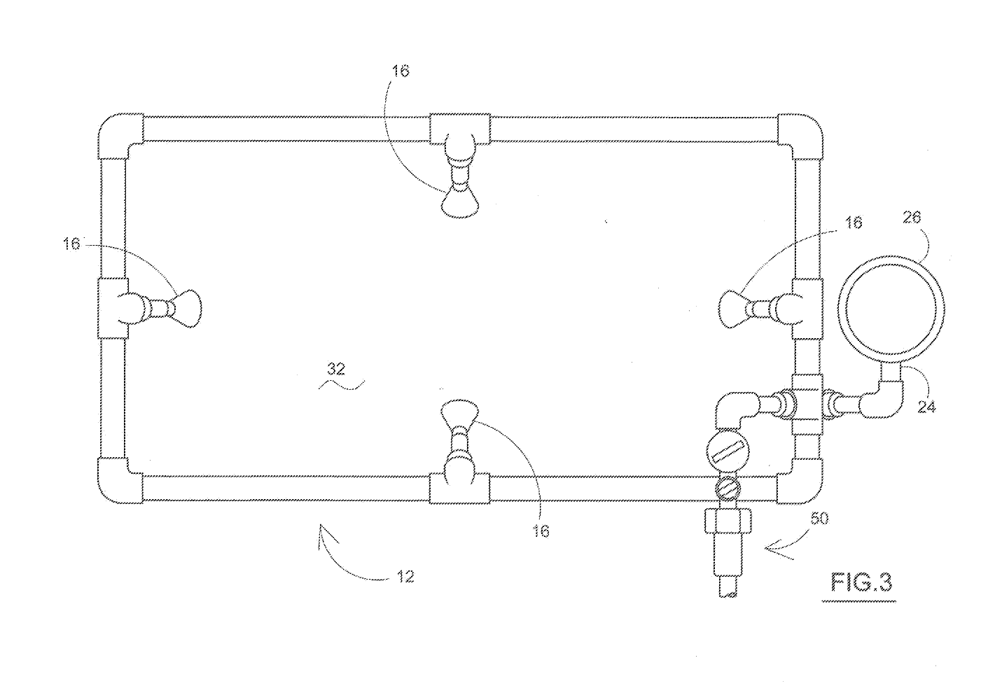

FIG. 4 is a rear view of one embodiment of the present invention.

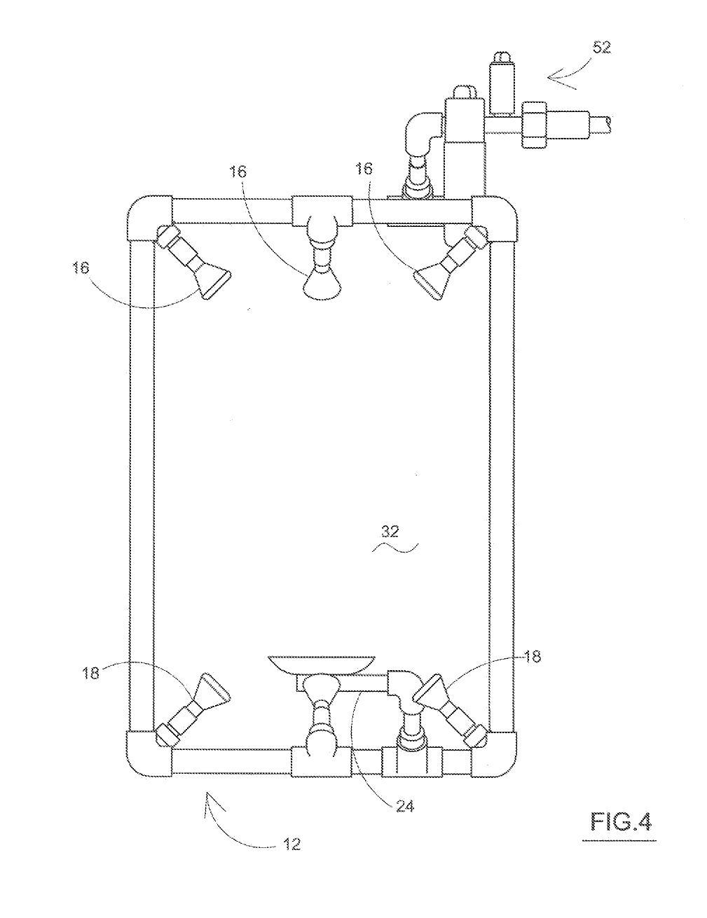

FIG. 5 is a front view without the screen according to one embodiment of the present invention.

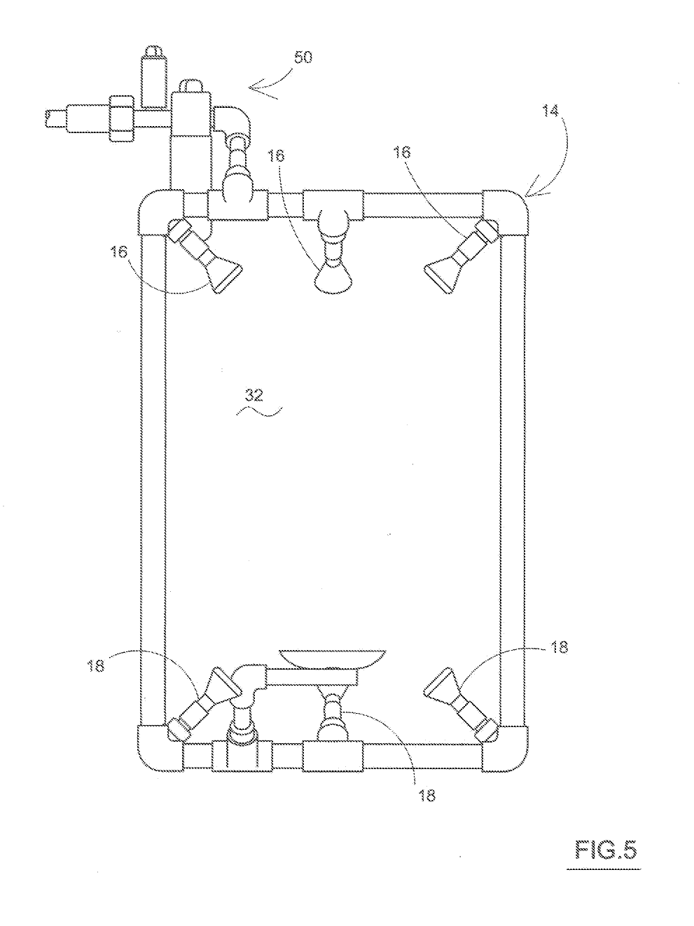

FIG. 6 is a top view with the screen according to one embodiment of the present invention.

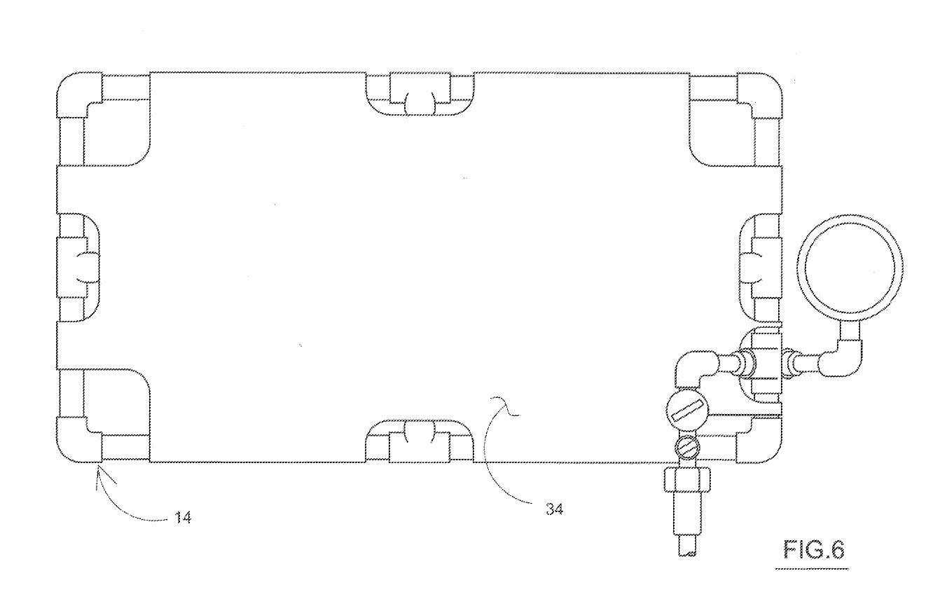

FIG. 7 is a rear view with the screen according to one embodiment of the present invention.

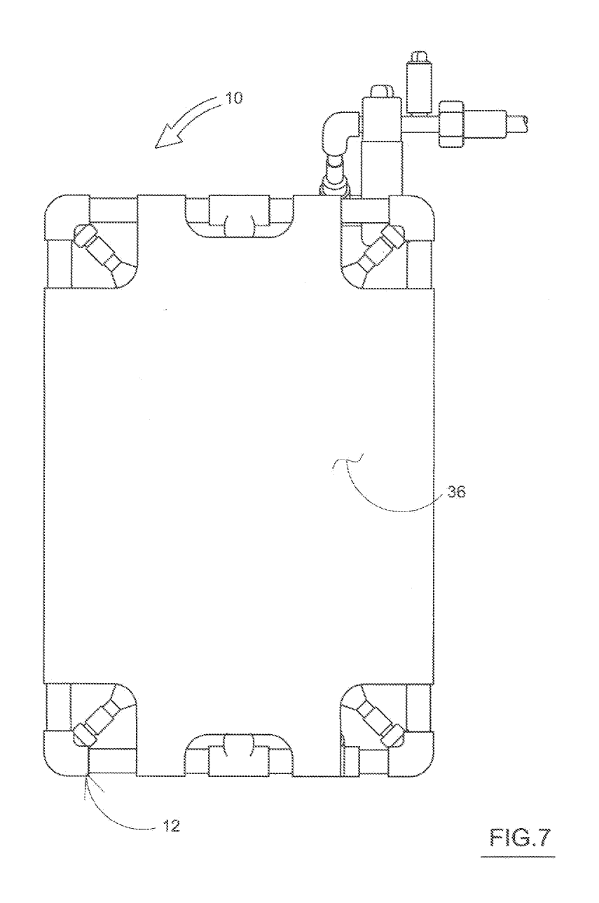

FIG. 8 is a front view with the screen according to one embodiment of the present invention.

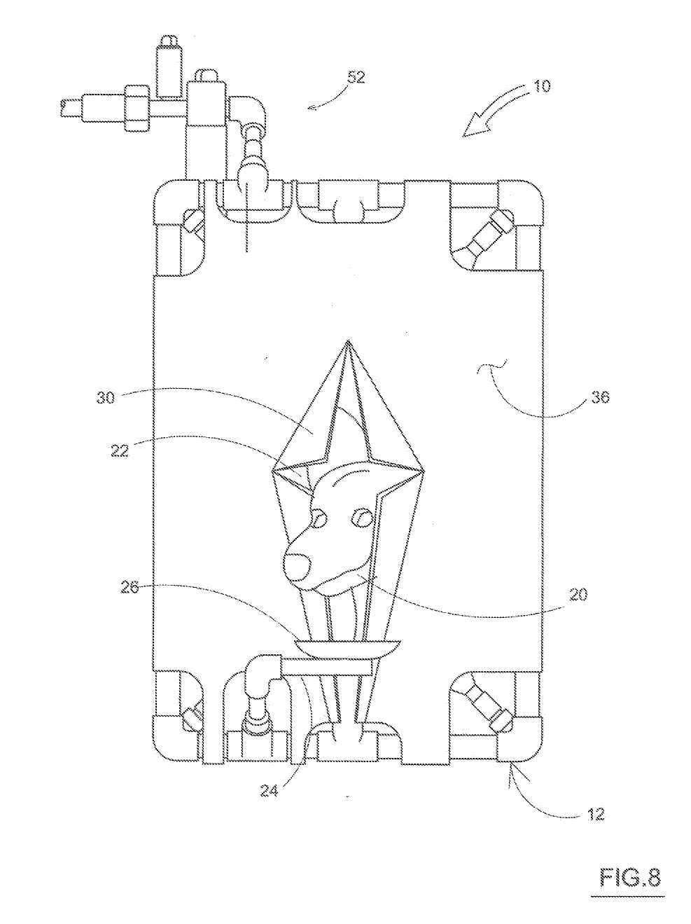

FIG. 9 is a side view with the screen according to one embodiment of the present invention.

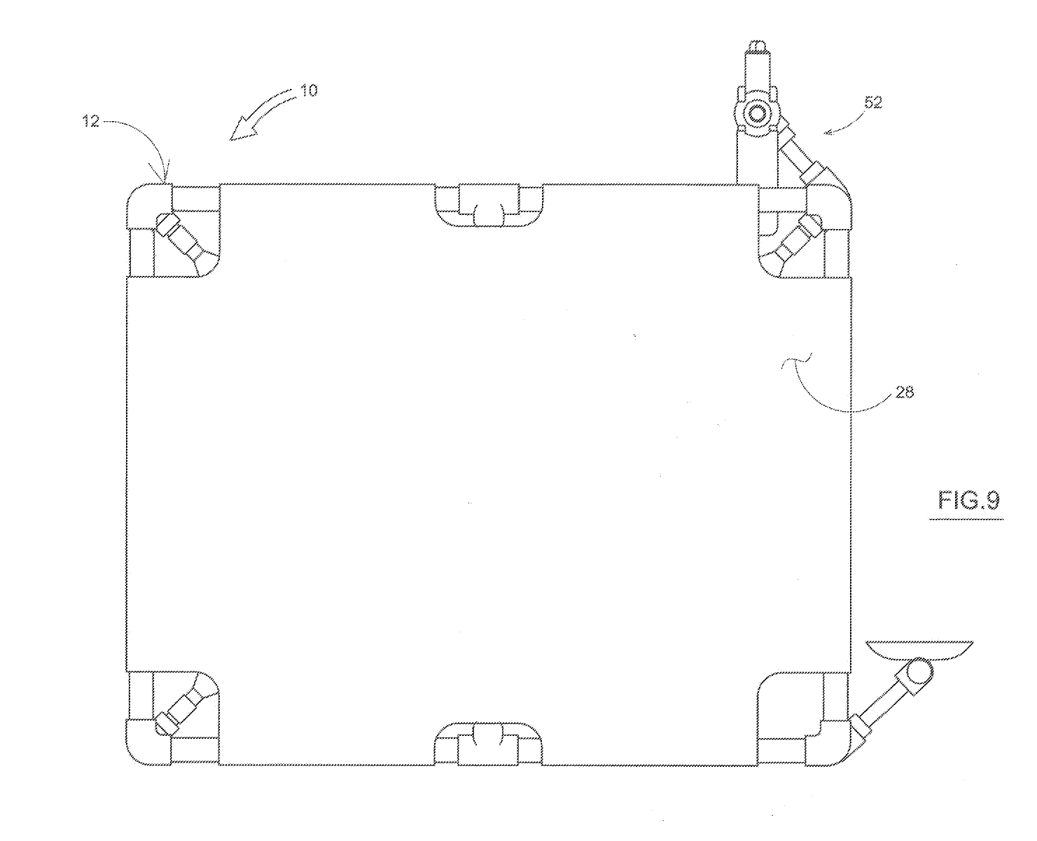

FIG. 10 is a side view of the water and soap dispensing system according to one embodiment of the present invention.

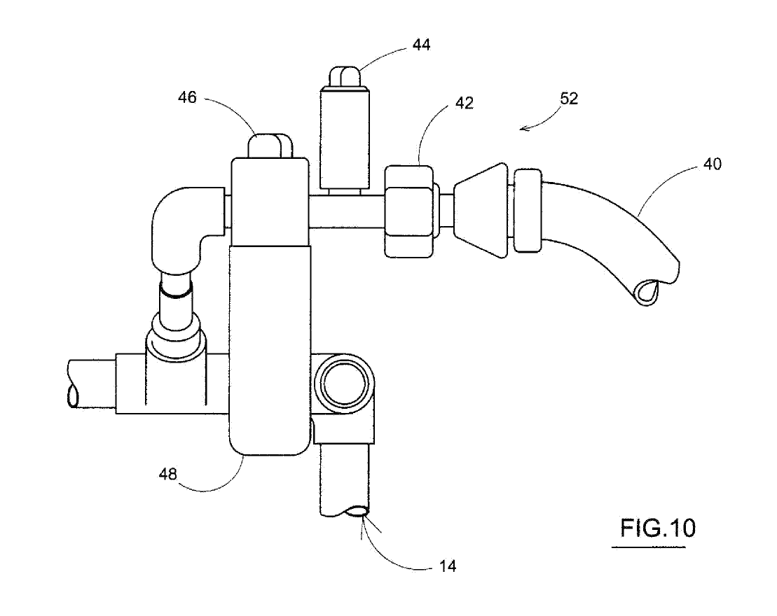

FIG. 11 is a top view of the water and soap dispensing system according to one embodiment of the present invention.

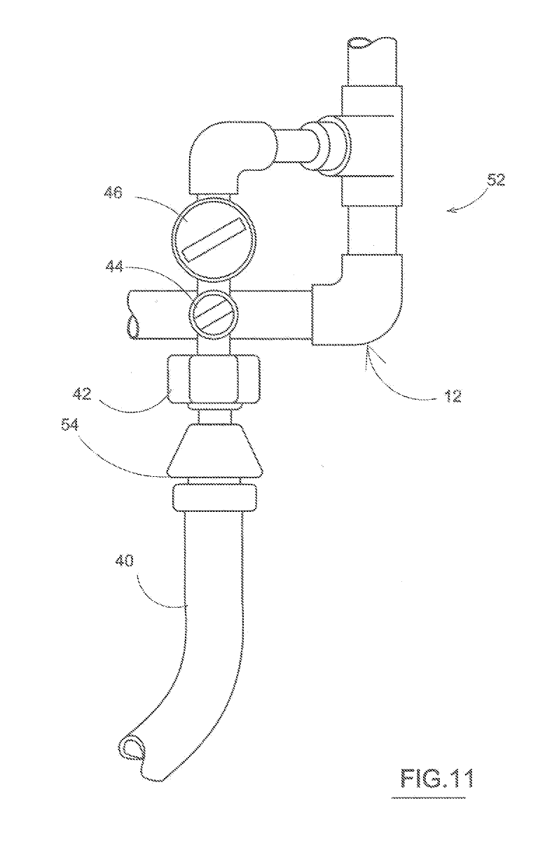

FIG. 12 is one embodiment demonstrative of dispensing air according to one embodiment of the present invention.

### DETAILED DESCRIPTION OF THE PREFERRED EMBODIMENT

The present invention relates generally to an animal care system. System 10 includes frame 12 and walls 28. In one embodiment, walls 28 enclose three of four vertical wall areas formed by frame 12. The fourth wall 38 is intended as an access to area 30 which is the de facto door 22 for allowing dog 20 ability for entering and leaving central cavity 32. As noted above, dog 20 is illustrative and the invention is contemplated as configurable to care for animals as desired including, but not limited to horses, cows, elephants, goats, sheep, and the like.

System 10 is configured with a plurality of showerheads including upper showerheads 16 and lower showerheads 18. Each of upper showerheads 16 and lower showerheads 18 are configured to individually deliver or cease delivery of water such that a user can select some or call of the showerheads being used at a particular time.

In one embodiment of the present invention, a standard inlet used for garden hoses is provided with system 10 whereby system 10 is connected to a standard outdoor garden hose in order to provide water supply for the system. In one embodiment frame 12 is configured as both a frame and a method of transporting the liquid whereby frame 14 includes one or more members having a hollow interior conduit fro transporting water from an inlet to the showerheads.

A dog 20 is led into system 10 through door 22 and positioned in central cavity 32. The head of dog 20 is positioned through a door 22 and a food dish 26 is on the outside of door 22 thus enticing a dog 20 to remain in position during a shower. In one embodiment, door opening 22 is restricted in size and configured that the head of the dog 20 fits through, but that the dog cannot step through door opening 22 and exit central cavity 32. Retaining bar 24 is constructed and arranged to encourage the dog to only extend their head outward from opening 22 thus having the majority and remainder of their body within the interior cavity 32 of system 10.

In one embodiment, one or more restraints are incorporated into system 10 in order to impede the dog from unwanted movement.

In one embodiment, the garden hose 40 is connected to inlet 42. Water valve 44 controls the inlet of water to system 10. Soap dispenser assembly 52 has a soap reservoir 48 and a selectivity valve 46 that is user adjustable for controlling the amount of soap dispensed in the system. As is known, valve 46 can provide water only or a desired amount of soap by adjusting the valve accordingly. System inlet 50 receives water and work water soap mixture from soap dispenser assembly 52 and distributes the water and warm water mixed with soap to each of upper showerheads 16 and lower showerheads 18.

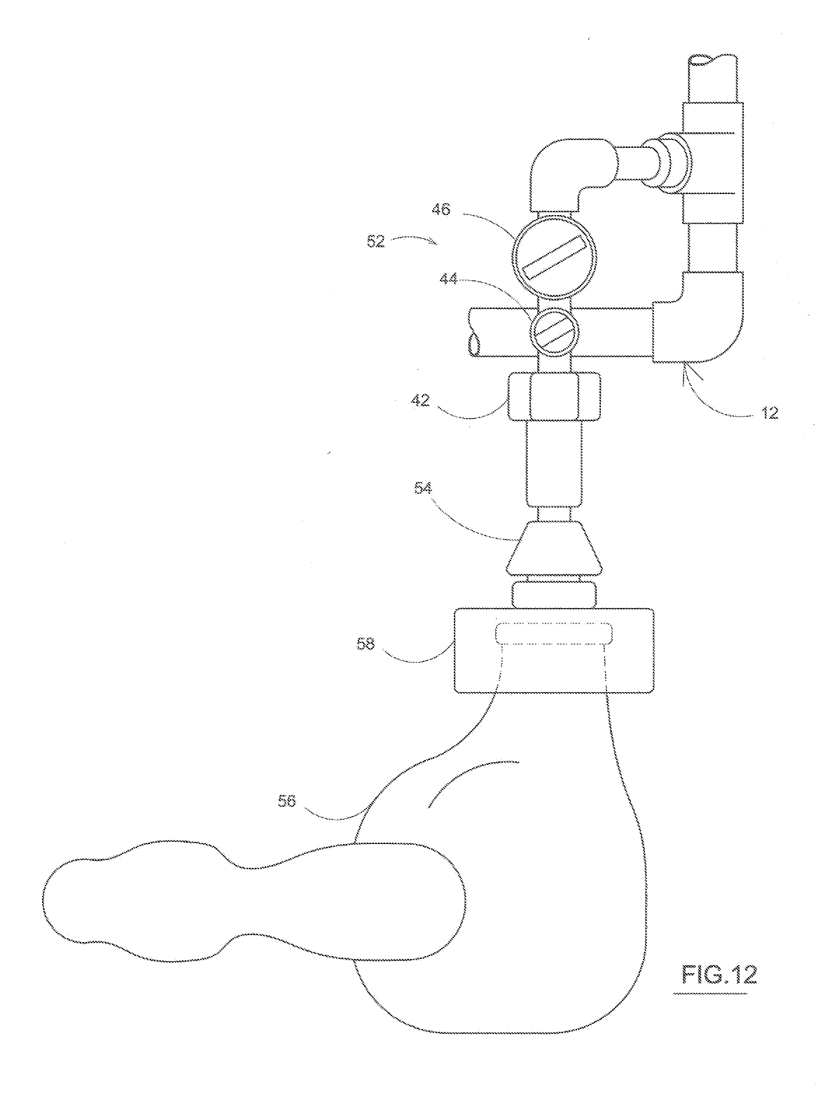

In one embodiment, the “shower” is actually a shower of gas. As shown in FIG. 12, the present invention is configured with a gas inlet 56 connected to gas inlet adapter 58 and system connector 54. In one embodiment, the gas is dry and/or heated air for delivery through nozzles to dry an animal placed in cavity 32.

The drying nozzles would be similarly positioned as any of upper showerheads 16 and lower showerheads 18. Thus, in one embodiment, a single system is configured to wash the dog and then provide air to dry the dog. In one embodiment utilizing water and air inlets, a valve selecting air and water is utilized. Additionally, the system is configured in one embodiment to deliver warm and/or heated air to help dry the animal after a shower.

In another embodiment, an animal in need of a particular therapy delivered as a gas will utilize the system. In one non-limiting example, an animal with parasites, fleas, mites and the like can receive a fumigation treatment in a system configured to deliver a therapeutic gas.

Additionally, although the drawings are demonstrative of a dog, in one embodiment, it is contemplated as being configured as desired for other animals.

In one mode of use, a dog 20 is positioned in cavity 32 of system 10. Hose 40 is connected and reservoir 48 is filled with a soap or other appropriate cleaning solution. Water is delivered to system 10 through hose 40 and selectivity valve 46 is positioned to allow for inlet water through hose 40 to uptake soap from reservoir 48 and the combined soap/water solution passes through the interior hollow portions of frame 14 and is delivered through any one or all of shower heads 16 and 18 as desired.

In one embodiment, frame 10 is formed with certain flexible hollow portions that allow for frame 10 to be folded for ease of transport and storage.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

What is claimed is:

1. An animal care assembly comprising:
a frame defining a multisided solid and a central cavity therein;
a plurality of delivery structures being showerheads or outlet nozzles within said central cavity;
a plurality of wall sections on said frame wherein one wall has an opening constructed and arranged for accommodating an animal's head; and
a water inlet structure operatively associated with said delivery structures for supplying water from said inlet through a connected conduit to each of said delivery structures.

2. The assembly of claim 1 further comprising a retaining bar on an exterior portion of said frame for inhibiting an animal from exiting through said wall opening.

3. The assembly of claim 1 wherein said conduits are constructed as frame members having a hollow interior configured to transport water from said inlet to said showerheads.

4. The assembly of claim 1 wherein said opening is selectively adjustably size restrictive in construction to prevent an animal from passing through.

5. The assembly of claim 1 including a cleaning solution reservoir and a valve configured for selective delivery of a cleaning solution concurrently with water supplied through said inlet.

6. The assembly of claim 1 further including a gas inlet configured to deliver gas through said delivery structures.

7. The assembly of claim 1 wherein said gas inlet includes a heater configured for heating gas delivered to said delivery structures.

8. The assembly of claim 6 further comprising metered-delivering components to deliver at least one therapeutic agent concurrently with said gas.
